(19) United States
(12) Patent Application Publication
(10) Pub. No.: US 2012/0062518 A1
(43) Pub. Date: Mar. 15, 2012

(54) Touch Sensing Systems

(75) Inventor: Adrian J. Cable, Cambridge (GB)

(73) Assignee: Light Blue Optics Ltd

(21) Appl. No.: 13/209,498

(22) Filed: Aug. 15, 2011

Related U.S. Application Data
(60) Provisional application No. 61/381,098, filed on Sep. 9, 2010.

(51) Int. Cl. G06F 3/042

(52) U.S. Cl. 345/175

(57) ABSTRACT

The invention relates to techniques for sensing of touch events near to a surface using position data from a pair of two-dimensional sensors (a camera and a quadrature detector). We describe apparatus for detecting the location of one or more objects on, or adjacent to, a surface, the apparatus comprising: an illuminator generating a generally planar fan of light above said surface; a pair of two-dimensional sensors, positioned above said surface comprising a camera, and a quadrature detector; and processing circuitry for receiving output from said sensors, and returning an estimate of said object location

### CROSS REFERENCE TO RELATED APPLICATION

This application claims priority to U.S. Provisional Patent Application No. 61/381,098 entitled “Touch Sensing Systems” and filed Sep. 9, 2010. The entirety of the aforementioned applications is incorporated herein by reference for all purposes.

### BACKGROUND OF THE INVENTION

This invention generally relates to techniques for sensing of touch events near to a surface using position data from a pair of two-dimensional sensors (a camera and a quadrature detector).

Arrangements for detecting touch events on (or close to) a surface, onto which a template may be placed or images projected, are known in the prior art. In particular, Montellese (U.S. Pat. No. 6,281,878) discloses forming a fan of light (such as infra-red light from a laser) parallel to, and slightly above, a surface, with a pair of two-dimensional sensors angled acutely to the surface, which pick up reflected (scattered) light from an object (such as a finger) impinging on the fan of light and, using triangulation, determine the location of the finger on the surface. Additionally, Lumio (U.S. Pat. No. 7,305,368) discloses a similar arrangement, using only a single two-dimensional sensor. Both arrangements have disadvantages in practice; the Montellese two-sensor approach potentially results in additional product cost compared to Lumio which utilizes only a single sensor, whereas Lumio is more sensitive to error in the detected position since triangulation cannot be employed.

Hence, for at least the aforementioned reasons, there exists a need in the art for advanced systems and methods for touch sensing.

### BRIEF DESCRIPTION OF THE DRAWINGS

Various aspects of the present invention are described, by way of example only, with reference to the accompanying FIGURE:

FIG. 1 shows a two-sensor embodiment showing side view (left) and plan view (right).

### BRIEF SUMMARY OF THE INVENTION

This invention generally relates to techniques for sensing of touch events near to a surface using position data from a pair of two-dimensional sensors (a camera and a quadrature detector).

This invention is concerned with a two-sensor approach. In preferred embodiments one of the two-dimensional sensors is a conventional camera, and the second of the two-dimensional sensors is a very low cost quadrature detector (essentially an array of 2×2 photodiodes). Embodiments of the invention provide for the improved accuracy possible through a triangulation approach, at minimal additional cost to a single-sensor (camera) approach. Position detection accuracy using this approach is strictly improved relative to using just a single camera sensor (as per Lumio '368), even given a significantly higher level of error expected from position sensing using a quadrature detector, relative to a camera.

The invention provides apparatus, methods and computer program code to implement such embodiments. The touch sensing system may be combined with a display device to provide a touch sensitive display. In particular a holographic display device may be employed, such as that described in our co-pending applications (hereby incorporated by reference): PCT/GB2009/051638; PCT/GB2009/051770; PCT/GB2009/051768; and Ser. No. 12/182,095.

Thus the invention provides apparatus for detecting the location of one or more objects on, or adjacent to, a surface, the apparatus comprising: an illuminator generating a generally planar fan of light above said surface; a pair of two-dimensional sensors, positioned above said surface comprising a camera, and a quadrature detector; and processing circuitry for receiving output from said sensors, and returning an estimate of said object location.

The invention also provides apparatus for detecting the location of one or more objects on, or adjacent to, a surface, the apparatus comprising: an optical system to generate a generally planar beam of light; a first imaging detector to image light scattered from said planar beam by a said object; a second detector to image light scattered from said planar beam by the said object, wherein said second detector has a lower resolution than said first detector, and wherein said first and second detectors are configured to image overlapping regions of said planar beam; and a processor coupled to said first and second detectors to jointly process data from said detectors to locate said object in a plane of said beam.

The invention also provides a touch sensitive display device comprising apparatus as described above.

### DETAILED DESCRIPTION OF PREFERRED EMBODIMENTS

### Touch Sensing Techniques

We describe a system for detecting touch events on or near a surface consisting of a “fan generator” which forms a fan of light (advantageously, but not limited to, invisible light such as infra-red light, so as not to result in visual disturbance to the user) above a surface. The fan of light may most advantageously be disposed parallel to the surface (to avoid intersection with, and hence scatter from, the surface), but in other embodiments may be disposed at an angle to the surface. A pair of sensors are disposed side-by-side at some distance above the surface, angled such that the field of view of the sensors captures the desired touch detection area, such that one or more objects (such as a finger) intersecting the fan of light will cause scatter, which is detected by a pair of sensors, configured (potentially with one or more lenses) such that the angle of light from the detected object to the sensor is converted to position of light detected on the sensor surface.

In embodiments, one of the sensors is a conventional camera, and the other is a quadrature detector, essentially a 2×2 array of photodiodes with processing to interpolate the signals from the photodiode array to provide an accurate measurement of the centroid of the light distribution incident on the array. In order to image the desired touch detection area onto the quadrature detector surface, a lens in front of the quadrature detector may be utilised, as with a camera. However, light scattered from a finger is likely to occupy such a small proportion of the field of view that to cover more than one of the photodiodes in the array (required for an accurate interpolated position measurement), it is advantageous to set the position of the lens such that the image of the touch detection area is defocused on the quadrature detector. This can be achieved by positioning the lens some distance in front of, or behind, the focal plane relative to the photodiode surface, but in other embodiments the photodiode surface may lie in the focal plane of the lens and an alternative means to spread light from the touch detection area onto the quadrature detector (such as a diffuser) may be employed.

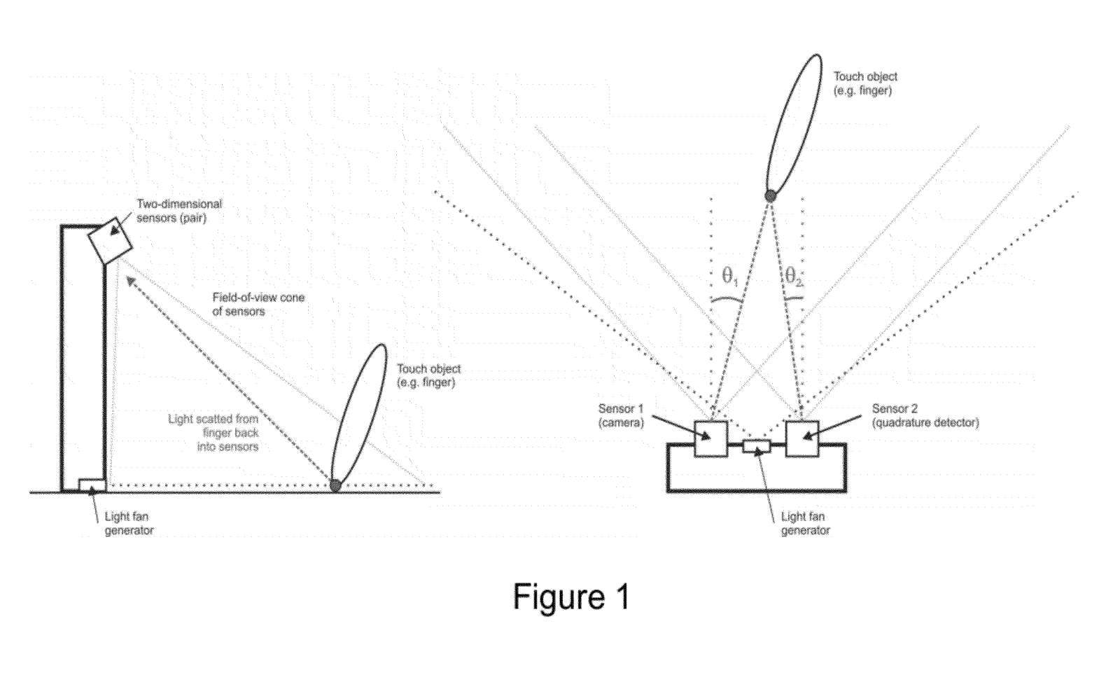

In FIG. 1, it can be seen how the angles horizontal to the lines subtended between sensors 1 and 2 and the touch object (e.g. finger) are given by θ₁ and θ₂ respectively. Additionally (not illustrated for clarity) the angles vertical to the lines subtended between sensors 1 and 2 and the touch object are given by φ₁ and φ₂ respectively. Those skilled in the art will recognize that, while FIG. 1 depicts the pair of sensors lying on a substantially similar horizontal plane, the sensors may equally instead be positioned one substantially above the other, or along any other line, with no material change to the operation.

As described previously, sensors 1 and 2 can be configured (for example with lenses and appropriate algorithms) such that the angles (θ₁, φ₁) and (θ₂, φ₂) of the centroid of incident light on the two sensors are converted to spatial coordinates (x₁, y₁) and (x₂, y₂) respectively. For a simple lens the correspondences are approximately proportionally given by x₁=tan θ₁, y₁=tan φ₁, x₂=tan φ₂, y₂=tan φ₂, although those skilled in the art will recognize that other correspondences may arise as a result of different lens designs used for the camera and quadrature detector and that this does not change the essence of the operation. The position of the touch object (X, Y) on the touch surface may then be computed by a pair of functions:

(X,Y)=(f(x₁,y₁,x₂,y₂),g(x₁,y₁,x₂,y₂))

such that the centroid positions detected by the two sensors are triangulated or otherwise combined to result in a combined centroid estimate more accurate than that achievable by either sensor alone. For multi-touch systems, positions of N multiple touch objects (X₁, Y₁) . . . (X_{N}, Y_{N}) can be detected and computed as:

(Xᵢ,Yᵢ)=(f(x₁ᵢ,y₁ᵢ,x₂ᵢ,y₂ᵢ),g(x₁ᵢ,y₁ᵢ,x₂ᵢ,y₂ᵢ))

where the index i in the above represents the index of the respective touch events.

Those skilled in the art will appreciate that, in a practical implementation, the functions f and g may additionally include correction for the geometry of the position and angle of the sensors relative to the surface, which will include keystone correction if (as in FIG. 1) the sensor is angled acute to the surface, and also potentially optical distortion (pincushion or barrel) correction, but without loss of generality we can neglect that level of detail here for simplicity.

As an example, consider:

X=f(x₁,y₁,x₂,y₂)=k·x₁+(1−k)x

Y=g(x₁,y₁,x₂,y₂)=k·y₁+(1−k)y₂

The constant k (which lies between 0 and 1 inclusive) in this example controls the relative weight of the measurement data used from both sensors to form the final touch object location estimate. A value of k=0.5 indicates equal weighting of data from both sensors; in practice, because data from the camera will be more accurate than data from the quadrature detector, k is likely to be greater than 0.5 (assuming sensor 1 is the camera, and sensor 2 is the quadrature detector). Let us consider estimates (X′, Y′) of the centroid position from the received data from both sensors. Considering for simplicity (without loss of generality) just X′, let the error in x₁ and x₂ from the camera and quadrature detector respectively be normally distributed with means 0 and variances ε1 and ε2 respectively. Then X′ will be normally distributed with mean X and variance (error) given by

ΔX′=k²·ε₁+(1−k)²ε₂

Taking partial derivatives with respect to k shows that the measurement error ΔX′ is minimized when k=ε₂/(ε₁+ε₂), which is strictly lower than either ε₁ or ε₂, regardless of their value, as long as the error variances are non-zero. Therefore, even if (owing to the necessarily low resolution of the quadrature detector, and the imprecision of the interpolation strategy used to detect centroid location at sub-element resolution) there is considerably greater inaccuracy in the data received from the quadrature detector than from the camera, this approach can always be used to improve the accuracy of the detected position location, and given the ready availability and simplicity of quadrature detectors, this improvement comes at a minimal cost.

### Holographic Image Display Systems

The above touch-sensing systems may optionally be combined with an image display system, for example a holographic image display system, to provide a touch-sensitive, preferably color, display.

We have previously described, in UK patent application number 0512179.3 filed 15 Jun. 2005, incorporated by reference, a holographic projection module comprising a substantially monochromatic light source such as a laser diode; a spatial light modulator (SLM) to (phase) modulate the light to provide a hologram for generating a displayed image; and a demagnifying optical system to increase the divergence of the modulated light to form the displayed image. Without the demagnifying optics the size (and distance from the SLM) of a displayed image depends on the pixel size of the SLM, smaller pixels diffracting the light more to produce a larger image. Typically an image would need to be viewed at a distance of several metres or more. The demagnifying optics increase the diffraction, thus allowing an image of a useful size to be displayed at a practical distance. Moreover the displayed image is substantially focus-free: that is the image is substantially in focus over a wide range or at all distances from the projection module.

A wide range of different optical arrangements can be used to achieve this effect but one particularly advantageous combination comprises first and second lenses with respective first and second focal lengths, the second focal length being shorter than the first and the first lens being closer to the spatial light modulator (along the optical path) than the second lens. Preferably the distance between the lenses is substantially equal to the sum of their focal distances, in effect forming a (demagnifying) telescope. In some embodiments two positive (i.e., converging) simple lenses are employed although in other embodiments one or more negative or diverging lenses may be employed. A filter may also be included to filter out unwanted parts of the displayed image, for example a bright (zero order) undiffracted spot or a repeated first order image (which may appear as an upside down version of the displayed image).

This optical system (and those described later) may be employed with any type of system or procedure for calculating a hologram to display on the SLM in order to generate the displayed image. However we have some particularly preferred procedures in which the displayed image is formed from a plurality of holographic sub-images which visually combine to give (to a human observer) the impression of the desired image for display. Thus, for example, these holographic sub-frames are preferably temporally displayed in rapid succession so as to be integrated within the human eye. The data for successive holographic sub-frames may be generated by a digital signal processor, which may comprise either a general purpose DSP under software control, for example in association with a program stored in non-volatile memory, or dedicated hardware, or a combination of the two such as software with dedicated hardware acceleration. Preferably the SLM comprises a reflective SLM (for compactness) but in general any type of pixellated microdisplay which is able to phase modulate light may be employed, optionally in association with an appropriate driver chip if needed.

A preferred procedure for calculating hologram data for display on SLM 24 is what we refer to, in broad terms, as One Step Phase Retrieval (OSPR) (although strictly speaking in some implementations it could be considered that more than one step is employed, as described for example in GB0518912.1 and GB0601481.5, incorporated by reference, where “noise” in one sub-frame is compensated in a subsequent sub-frame).

Thus we have previously described, in UK Patent Application No. GB0329012.9, filed 15 Dec. 2003, a method of displaying a holographically generated video image comprising plural video frames, the method comprising providing for each frame period a respective sequential plurality of holograms and displaying the holograms of the plural video frames for viewing the replay field thereof, whereby the noise variance of each frame is perceived as attenuated by averaging across the plurality of holograms.

Broadly speaking in our preferred method the SLM is modulated with holographic data approximating a hologram of the image to be displayed. However this holographic data is chosen in a special way, the displayed image being made up of a plurality of temporal sub-frames, each generated by modulating the SLM with a respective sub-frame hologram. These sub-frames are displayed successively and sufficiently fast that in the eye of a (human) observer the sub-frames (each of which have the spatial extent of the displayed image) are integrated together to create the desired image for display.

Each of the sub-frame holograms may itself be relatively noisy, for example as a result of quantising the holographic data into two (binary) or more phases, but temporal averaging amongst the sub-frames reduces the perceived level of noise. Embodiments of such a system can provide visually high quality displays even though each sub-frame, were it to be viewed separately, would appear relatively noisy.

A scheme such as this has the advantage of reduced computational requirements compared with schemes which attempt to accurately reproduce a displayed image using a single hologram, and also facilitate the use of a relatively inexpensive SLM.

Here it will be understood that the SLM will, in general, provide phase rather than amplitude modulation, for example a binary device providing relative phase shifts of zero and it (+1 and −1 for a normalised amplitude of unity). In preferred embodiments, however, more than two phase levels are employed, for example four phase modulation (zero, π/2, π, 3π/2), since with only binary modulation the hologram results in a pair of images one spatially inverted in respect to the other, losing half the available light, whereas with multi-level phase modulation where the number of phase levels is greater than two this second image can be removed. Further details can be found in our earlier application GB0329012.9 (ibid), hereby incorporated by reference in its entirety.

Although embodiments of the method are computationally less intensive than previous holographic display methods it is nonetheless generally desirable to provide a system with reduced cost and/or power consumption and/or increased performance. It is particularly desirable to provide improvements in systems for video use which generally have a requirement for processing data to display each of a succession of image frames within a limited frame period.

We have also described, in GB0511962.3, filed 14 Jun. 2005, a hardware accelerator for a holographic image display system, the image display system being configured to generate a displayed image using a plurality of holographically generated temporal sub-frames, said temporal sub-frames being displayed sequentially in time such that they are perceived as a single reduced-noise image, each said sub-frame being generated holographically by modulation of a spatial light modulator with holographic data such that replay of a hologram defined by said holographic data defines a said sub-frame, the hardware accelerator comprising: an input buffer to store image data defining said displayed image; an output buffer to store holographic data for a said sub-frame; at least one hardware data processing module coupled to said input data buffer and to said output data buffer to process said image data to generate said holographic data for a said sub-frame; and a controller coupled to said at least one hardware data processing module to control said at least one data processing module to provide holographic data for a plurality of said sub-frames corresponding to image data for a single said displayed image to said output data buffer.

In this preferably a plurality of the hardware data processing modules is included for processing data for a plurality of the sub-frames in parallel. In preferred embodiments the hardware data processing module comprises a phase modulator coupled to the input data buffer and having a phase modulation data input to modulate phases of pixels of the image in response to an input which preferably comprises at least partially random phase data. This data may be generated on the fly or provided from a non-volatile data store. The phase modulator preferably includes at least one multiplier to multiply pixel data from the input data buffer by input phase modulation data. In a simple embodiment the multiplier simply changes a sign of the input data.

An output of the phase modulator is provided to a space-frequency transformation module such as a Fourier transform or inverse Fourier transform module. In the context of the holographic sub-frame generation procedure described later these two operations are substantially equivalent, effectively differing only by a scale factor. In other embodiments other space-frequency transformations may be employed (generally frequency referring to spatial frequency data derived from spatial position or pixel image data). In some preferred embodiments the space-frequency transformation module comprises a one-dimensional Fourier transformation module with feedback to perform a two-dimensional Fourier transform of the (spatial distribution of the) phase modulated image data to output holographic sub-frame data. This simplifies the hardware and enables processing of, for example, first rows then columns (or vice versa).

In preferred embodiments the hardware also includes a quantizer coupled to the output of the transformation module to quantise the holographic sub-frame data to provide holographic data for a sub-frame for the output buffer. The quantizer may quantize into two, four or more (phase) levels. In preferred embodiments the quantizer is configured to quantise real and imaginary components of the holographic sub-frame data to generate a pair of sub-frames for the output buffer. Thus in general the output of the space-frequency transformation module comprises a plurality of data points over the complex plane and this may be thresholded (quantised) at a point on the real axis (say zero) to split the complex plane into two halves and hence generate a first set of binary quantised data, and then quantised at a point on the imaginary axis, say 0j, to divide the complex plane into a further two regions (complex component greater than 0, complex component less than 0). Since the greater the number of sub-frames the less the overall noise this provides further benefits.

Preferably one or both of the input and output buffers comprise dual-ported memory. In some particularly preferred embodiments the holographic image display system comprises a video image display system and the displayed image comprises a video frame.

In an embodiment, the various stages of the hardware accelerator implement a variant of the algorithm given below, as described later. The algorithm is a method of generating, for each still or video frame I=/I_{xy}, sets of N binary-phase holograms h⁽¹⁾ . . . H^{(N)}. Statistical analysis of the algorithm has shown that such sets of holograms form replay fields that exhibit mutually independent additive noise.

$$1. Let {G}_{xy}^{( n )} = {I}_{xy} exp ( {jϕ}_{xy}^{( n )} )$$

$$where {ϕ}_{xy}^{( n )} is uniformly distributed between 0$$

$$and 2 π for 1 \leq n \leq N \text{/} 2 and 1 \leq x , y \leq m$$

$$2. Let {g}_{uv}^{( n )} = {F}^{- 1} [ {G}_{xy}^{( n )} ]$$

$$where$$

$${F}^{- 1} represents the two \text{-} dimension al inver se F our ier transform operator , \\ for 1 \leq n \leq N \text{/} 2$$

$$3. Let {m}_{uv}^{( n )} = \{ {g}_{uv}^{( n )} \} for 1 \leq n \leq N \text{/} 2$$

$$4. Let {m}_{uv}^{( n + N / 2 )} = ℱ \{ {g}_{uv}^{( n )} \} for 1 \leq n \leq N \text{/} 2$$

$$5. Let {h}_{uv}^{( n )} = \{ \begin{matrix}- 1 & if {m}_{uv}^{( n )} < {Q}^{( n )} \\ + 1 & if {m}_{uv}^{( n )} \geq {Q}^{( n )}\end{matrix} \\ where {Q}^{( n )} = median ( {m}_{uv}^{( n )} ) and 1 \leq n \leq N .$$

Step 1 forms N targets G_{xy}⁽ⁿ⁾ equal to the amplitude of the supplied intensity target I_{xy}, but with independent identically-distributed (i.i.t.), uniformly-random phase. Step 2 computes the N corresponding full complex Fourier transform holograms gᵤᵥ⁽ⁿ⁾. Steps 3 and 4 compute the real part and imaginary part of the holograms, respectively. Binarization of each of the real and imaginary parts of the holograms is then performed in step 5: thresholding around the median of mᵤᵥ⁽ⁿ⁾ ensures equal numbers of −1 and 1 points are present in the holograms, achieving DC balance (by definition) and also minimal reconstruction error. In an embodiment, the median value of mᵤᵥ⁽ⁿ⁾ is assumed to be zero. This assumption can be shown to be valid and the effects of making this assumption are minimal with regard to perceived image quality. Further details can be found in the applicant's earlier application (ibid), to which reference may be made. More details can also be found in WO2007/031797 and WO2007/085874; in the applicant's international patent application number PCT/GB2007/050157 filed 27 Mar. 2007, hereby incorporated by reference in its entirety; and for color displays in in PCT/GB2007/050291, also hereby incorporated by reference.
Holographic Projection at an Ecute Angle onto a Surface

We have previously described, in U.S. Ser. No. 12/335,423 (incorporated by reference) a holographic image projection system for projecting an image at an acute angle onto a surface, the system comprising: a spatial light modulator (SLM) to display a hologram; an illumination system to illuminate said displayed hologram; projection optics to project light from said illuminated displayed hologram onto said surface at an acute angle form said image; and a processor having an input to receive input image data for display and an output to provide hologram data for said spatial light modulator, and wherein said processor is configured to: input image data; convert said input image data to target image data; generate from said target image data hologram data for display as a hologram on said spatial light modulator to reproduce a target image corresponding to said target image data; and output said hologram data for said spatial light modulator; and wherein said target image is distorted to compensate for said projection of said hologram at an acute angle to form said image.

In embodiments of the system, because diffraction is employed light from the entire illuminated area of the hologram can be directed into the distorted target image field. Moreover, the displayed image is substantially focus-free; that is the focus of the displayed image does not substantially depend upon the distance from the holographic image projection system to the display surface. A demagnifying optical system may be employed to increase the divergence of the modulated light to form the displayed image, thus allowing an image of a useful size to be displayed at a practical distance.

The field of the displayed image suffers from keystone distortion, the trapezoidal distortion of a nominally rectangular input image field caused by projection onto a surface at an angle which is not perpendicular to the axis of the output optics. Thus the holographic image projection system internally generates a target image to which the inverse distortion has been applied so that when this target image is projected holographically the keystone distortion is compensated. The target image is the image to which a holographic transform is applied to generate hologram data for display on the SLM. Thus in some preferred embodiments the system also includes non-volatile memory storing mapping data for mapping between the input image and the target image.

To convert from the input image to the target image either forward or reverse mapping may be employed, but preferably the latter, in which pixels of the target image are mapped to pixels of the input image, a value for a pixel of the target image then being a assigned based upon lookup of the value of the corresponding pixel in the input image. Thus in some preferred embodiments the trapezoidal shape of the target image field is located in a larger, for example rectangular target image (memory) space and then each pixel of the target image field is mapped back to a pixel of the (undistorted) input image and this mapping is then used to provide values for the pixels of the target image field. This is preferable to a forward mapping from the input image field to the distorted target image field for reasons which are explained below. In either case, however, in some preferred embodiments the holographic transform is only applied to the distorted, generally trapezoidal target image field rather than to the entire (rectangular) target image memory space, to avoid performing unnecessary calculations.

Where reverse mapping as described above, is employed preferably compensation is also applied for variations in per unit area brightness of the projected image due to the acute angle projection. Thus while diffraction from a given pixel of the SLM will contribute to substantially the entire displayed hologram, nonetheless the diffracted light from this pixel will be distorted resulting in more illumination per unit area at the short-side end of the trapezoid as compared with the long-side end of the trapezoid. Thus in preferred embodiments an amplitude or intensity scale factor is applied the value of which depends upon the location (in two dimensions) of a pixel in the target image space. This amplitude/intensity compensation may be derived from a stored amplitude/intensity map determined, for example, by a calibration procedure or it may comprise one or a product of partial derivatives of a mapping function from the input image to the anti-distorted target image. Thus, broadly speaking, the amplitude/intensity correction may be dependent on a value indicating what change of area in the original, input image results from a change of area in the anti-distorted target image space (at the corresponding position) by the same amount.

As mentioned above, rather than a reverse mapping a forward mapping from the input image space to the distorted target image space may alternatively be employed. This is in general less preferable because such a mapping can leave holes in the (anti-) distorted target image where, in effect, the target image is stretched. Thus mapping pixels of the input image to pixels of the target image may not populate all the pixels of the target image with values. One approach to address this issue is to map a pixel of the input image to an extended region of the target image, for example, a regular or irregular extended spot. In this case a single pixel of the input image may map to a plurality of pixels of the target image. Alternatively once pixel values of the target image have been populated using pixels of the input image, pixels of the target image which remain unpopulated may be given values by interpolation between pixels of the target image populated with pixel values. Where a single input image pixel is mapped to an extended region of the target image, these extended regions or spots may overlap in the target image, in which case the value of a target image pixel may be determined by combining more particularly summing, the overlapping values (so that multiple input image pixels may contribute to the value of a single target image pixel). With this approach compensation for per unit area brightness variation is achieved automatically by the summing of the values of the extended spots where these spots overlap in the target image field.

Preferred embodiments of the holographic image projection system provide a multi-color, more particularly a full color display. Thus red, green and blue laser illumination of the SLM may be employed, time multiplexed to display three color planes of the input image in turn. However, since the projection system operates by diffraction, the blue light diverges less than the red light and thus in preferred embodiments the target image also has three color planes in which a different scaling is employed for each color, to compensate for the differing sizes of the projected color image planes. More particularly, since the red light diverges most, the target image field of the red color plane is the smallest target image field of the three target image planes (since the target image has “anti-distortion” applied). In general the size of the target image field for a color is inversely proportional to the wavelength of light used for that color. In some preferred embodiments, however, rather than a simple scaling by wavelength being applied the distortion (more correctly anti-distortion) of each color image plane may be mapped to a corresponding color plane of the target image field using a calibration process which corrects for chromatic aberration within the projection system such as chromatic aberration within the projection optics, chromatic aberration caused by slight misalignment between rays for different colors within the optics, and the light.

We have also described a holographic image projection system processor configured to perform the above described image input, conversion to an anti-distorted target image, and generation of hologram data from the target image.

The holographic techniques employed in preferred embodiments of the projector facilitate miniaturization of the projector. These techniques also facilitate handling of extreme distortion caused by projection onto a surface on which the projector is placed, this extreme distortion resulting from the geometry illustrated in later FIG. 1c in combination with the small size of the projector. Thus in some preferred embodiments the surface onto which the image is projected is no more than 1 m, 0.5 m, 0.3 m, 0.2 m, 0.15 m, or 0.1 m away from the output of the projection optics 102. Similarly in embodiments the distance from the output of the projection optics to the furthest edge of the displayed image (d2 in FIG. 1c later) is substantially greater than the distance from the output of the projection optics to the nearest edge of the displayed image (d1 in FIG. 1c), for example 50%, 100%, 150%, 200% or 250% greater. Depending upon the geometry the acute projection angle (angle θ in FIG. 1c) may be less than 70°, 65°, 60°, 55°, 50°, or even 45°.

We have also described a holographic image projection device having two configurations, a first configuration in which said device is able to project towards a vertical screen or surface and a second, table down projection configuration in which said device is configured to stand on a table surface and project downwards into said table surface, and wherein the device is further configured to apply distortion compensation to a holographically projected image when in said table down projection configuration, said distortion compensation compensating for distortion arising from projection of said image onto said table surface at an acute angle.

In some preferred embodiments the device incorporates a stand such as a bipod or tripod stand, and preferably also includes a sensor to automatically detect when the device is in its table-down projection configuration, automatically applying distortion compensation in response to such detection. However in some alternative arrangements rather than mechanically tilting the device, instead the projection optics may be adjusted to alter between forward and table-down projection, again preferably automatically sensing the configuration. In a simple configuration this could be achieved with a moveable or switchable minor, but an alternative approach employs a wide angle or fisheye lens which when translated perpendicular to the output axis of the optics may be employed to move from forward projection to table-down projection at an acute angle.

We have also described a method of projecting an image onto a surface at an acute angle, the method comprising: inputting display image data defining an image for display; processing said display image data to generate target image data defining a target image for projection, wherein said target image comprises a version of said image for display distorted to compensate for projection onto said surface at said acute angle; performing a holographic transform on said target image defined by said target image data to generate hologram data for a hologram of said target image; displaying said hologram data on a spatial light modulator illuminated by at least one laser; and projecting light from said at least one laser modulated by said hologram data displayed on said spatial light modulator onto said surface at said acute angle, to reproduce a substantially undistorted version of said image on said surface.

As previously described, a mapping between the input image and the anti-distorted target image may comprise either an analytical mapping, based on a mathematical function, or a numerical mapping, for example, derived from a calibration procedure or both. As previously mentioned in some preferred embodiment target image pixels are mapped to input image pixels to lookup target image pixel values. Preferably the target image is also corrected for area mapping distortion and, in a color system, preferably the different color planes are appropriately scaled so that they reproduced in the projection surface at substantially the same size.

We have also described processor control code to implement the above-described methods, in particular on a data carrier such as a disk, CD- or DVD-ROM, programmed memory such as read-only memory (Firmware). Code (and/or data) to implement embodiments of the invention may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog (Trade Mark) or VHDL (Very high speed integrated circuit Hardware Description Language). As the skilled person will appreciate such code and/or data may be distributed between a plurality of coupled components in communication with one another.

Thus we have also described a carrier carrying processor control code to implement a method of projecting an image onto a surface at an acute angle, the method comprising: inputting display image data defining an image for display; processing said display image data to generate target image data defining a target image for projection, wherein said target image comprises a version of said image for display distorted to compensate for projection onto said surface at said acute angle; performing a holographic transform on said target image defined by said target image data to generate hologram data for a hologram of said target image; and outputting said hologram data for display of said hologram on a spatial light modulator (SLM) for reproducing said image for display on said surface.

In preferred embodiments of the above described projection systems, devices and methods preferably an (AD)OSPR-type procedure is employed to generate the hologram data. Thus in preferred embodiments a single displayed image or image frame is generated using a plurality of temporal holographic subframes displayed in rapid succession such that the corresponding images average in an observer's eye to give the impression of a single, noise-reduced displayed image.

Applications for the described techniques we have described include in particular (but are not limited to) the following: mobile phone; PDA; laptop; digital camera; digital video camera; games console; in-car cinema; navigation systems (in-car or personal e.g. wristwatch GPS); head-up and helmet-mounted displays for automobiles and aviation; watch; personal media player (e.g. MP3 player, personal video player); dashboard mounted display; laser light show box; personal video projector (a “video iPod®” concept); advertising and signage systems; computer (including desktop); remote control unit; an architectural fixture incorporating a holographic image display system; more generally any device where it is desirable to provide a touch-sensitive image display system.

Thus we also provide a method of sharing a touch sensitive image between a group of people, the method comprising: providing a holographic image projection device having a table-down projection configuration in which said device is configured to stand on a table surface and project downwards onto said table surface; projecting an image holographically onto said table surface to share said image; and providing touch sensitivity as previously described. No doubt many effective alternatives will occur to the skilled person and it will be understood that the invention is not limited to the described embodiments and encompasses modifications apparent to those skilled in the art lying within the spirit and scope of the claims appended hereto.

In conclusion, the invention provides novel systems, devices, methods and arrangements for touch sensing. While detailed descriptions of one or more embodiments of the invention have been given above, no doubt many other effective alternatives will occur to the skilled person. It will be understood that the invention is not limited to the described embodiments and encompasses modifications apparent to those skilled in the art lying within the spirit and scope of the claims appended hereto.

What is claimed is:

1. Apparatus for detecting the location of one or more objects on, or adjacent to, a surface, the apparatus comprising:
an illuminator generating a generally planar fan of light above said surface;
a pair of two-dimensional sensors, positioned above said surface comprising a camera, and a quadrature detector; and
processing circuitry for receiving output from said sensors, and returning an estimate of said object location.

2. Apparatus according to claim 1 where the planar fan of light is substantially parallel to said surface.

3. Apparatus according to claim 1 where the planar fan of light is angled towards, and intersects with said surface.

4. Apparatus according to claim 1 where the planar fan of light is angled away from, and does not intersect with, said surface.

5. Apparatus according to claim 1 where the estimate of said object location is more accurate than that obtainable through either sensor alone.

6. Apparatus according to claim 1 where the estimate of said object location is obtained through triangulation of position data from said two-dimensional sensors.

7. Apparatus according to claim 1 where the light formed by the illuminator is non-visible.

8. Apparatus according to claim 1 where the illuminator is a laser.

9. Apparatus according to claim 1 where the quadrature detector comprises at least 2×2 light sensing elements.

10. Apparatus according to claim 9 where the light sensing elements of the quadrature detector are photodiodes.

11. Apparatus according to claim 1 where the sensors include optics to detect the angles subtended by said object location and said sensor.

12. Apparatus for detecting the location of one or more objects on, or adjacent to, a surface, the apparatus comprising:
an optical system to generate a generally planar beam of light;
a first imaging detector to image light scattered from said planar beam by a said object;
a second detector to image light scattered from said planar beam by the said object, wherein said second detector has a lower resolution than said first detector, and wherein said first and second detectors are configured to image overlapping regions of said planar beam; and
a processor coupled to said first and second detectors to jointly process data from said detectors to locate said object in a plane of said beam.

13. Apparatus as claimed in claim 12 wherein said second detector is a quadrature detector, and wherein said joint processing comprises determining a combined centroid estimate from said data from both of said detectors.

14. Apparatus as claimed in claim 12 or 13 wherein said image of said scattered light on second detector is defocussed.

15. A touch sensitive display device comprising the apparatus of any one of claims 1 to 14.

16. A holographic image projection system for projecting an image at an acute angle onto a surface, the system comprising:
a spatial light modulator (SLM) to display a hologram;
an illumination system to illuminate said displayed hologram;
projection optics to project light from said illuminated displayed hologram onto said surface at an acute angle form said image; and
a processor having an input to receive input image data for display and an output to provide hologram data for said spatial light modulator, and wherein said processor is configured to:
input image data;
convert said input image data to target image data;
generate from said target image data hologram data for display as a hologram on said spatial light modulator to reproduce a target image corresponding to said target image data; and
output said hologram data for said spatial light modulator; and
wherein said target image is distorted to compensate for said projection of said hologram at an acute angle to form said image; and
apparatus as claimed in any one of claims 1 to 14 for detecting the location of a user interaction with said image.

17. A holographic image projection system as claimed in claim 16 wherein said conversion of said input image data to said target image data comprises mapping pixels of said target image data to pixels of said input image data and looking up values for said pixels of said target image data in said input image data.

18. A holographic image projection system as claimed in claim 16 wherein said conversion of said input image data to said target image data comprises mapping pixels of said input image data to pixels of said target image data such that a plurality of pixels of said target image data have values dependent on a single pixel of said input image data and additionally or alternatively such that a single pixel of said target image data has a value dependent on values of a plurality of pixels of said input image data.

19. A holographic image projection system as claimed in claim 16 wherein said conversion of said input image data to said target image data further comprises compensating for variations in per unit area brightness of said projected image due to said acute angle projection.

20. A holographic image projection system as claimed in claim 16 wherein said projected image comprises a multicolor image, wherein said illumination system comprises a multicolor illumination system and, wherein said conversion of said input image data to said target image data comprises compensating for different scaling of different color components of said multicolor projected image due to said holographic projection.

21. A holographic image projection system as claimed in claim 20 wherein said compensating further comprises compensating for different aberrations of said different color components by spatial mapping of said aberrations for a said color component.

22. A holographic image projection system as claimed in claim 16 wherein said processor is configured to generate from said target image data hologram data for display by omitting to process portions of target image space in which said target image data is located from which data for said image is absent.
